(19) United States
(12) Patent Application Publication
(10) Pub. No.: US 2013/0186117 A1
(43) Pub. Date: Jul. 25, 2013

(54) SYSTEM AND METHOD TO PROCESS INLET AIR

(71) Applicant: Bhalchandra Arun Desai, Atlanta, GA (US)

(72) Inventor: Bhalchandra Arun Desai, Atlanta, GA (US)

(73) Assignee: GENERAL ELECTRIC COMPANY, Schenectady, NY (US)

(21) Appl. No.: 13/354,443

(22) Filed: Jan. 20, 2012

(51) Int. Cl. F25D 17/04; G05D 23/19

(52) U.S. Cl. 62/94; 62/186; 62/93; 700/276

(57) ABSTRACT

A system to process inlet air includes a dehumidifying portion configured to dehumidify the inlet air. The system also includes a chilling portion configured to cool the inlet air, and bypass louvers configured to open and close, the bypass louvers being open to channel the inlet air to the chilling portion when the dehumidifying portion is not operational. A control portion of the system is configured to operate the bypass louvers.

### BACKGROUND OF THE INVENTION

The subject matter disclosed herein relates to processing ambient air at the inlet of a gas turbine.

The ambient air at the inlet of a compressor portion of a turbomachine is preferably cool and dry. Prior art turbomachine systems include inlet air cooling technologies such as evaporative coolers or inlet chillers or foggers. Each of the systems is best suited for certain ambient conditions. For example, evaporative coolers and foggers work best when the ambient conditions are hot and dry, because the effectiveness of an evaporative cooler depends on the ambient wet bulb temperature, which becomes less effective in hot and moist environments. Inlet chillers work in any ambient condition, but, as the moisture content in ambient air increases, an increasing portion of the chilling system's capacity is used to remove moisture from the air. To mitigate this issue, chiller systems must be oversized to remove moisture as well as cool the ambient air. As a result, chiller systems have a high overall design capacity (tonnage) that warrants a larger number of chillers and large cooling towers and chilling coils. A more robust and efficient processing system for ambient air would be appreciated in the turbomachine industry.

### BRIEF DESCRIPTION OF THE INVENTION

According to one aspect of the invention, a system to process inlet air includes a dehumidifying portion configured to dehumidify the inlet air; a chilling portion configured to cool the inlet air; bypass louvers configured to open and close, the bypass louvers being open to channel the inlet air to the chilling portion when the dehumidifying portion is not operational; and a control portion configured to operate the bypass louvers.

According to another aspect of the invention, a method of processing inlet air includes controlling dehumidification processing of the inlet air; controlling bypass louvers based on the dehumidification processing, the bypass louvers being controlled to open when the inlet air does not undergo the dehumidification processing; and performing chilling processing of the inlet air.

According to yet another aspect of the invention, a computer-readable medium storing instructions that, when processed by a processor, cause the processor to execute a method of processing inlet air. The method includes controlling dehumidification processing of the inlet air; controlling bypass louvers based on the dehumidification processing, the bypass louvers being controlled to open when the inlet air does not undergo the dehumidification processing; and performing chilling processing of the inlet air.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a block diagram of an inlet air processing system according to an embodiment of the invention;

FIG. 2 illustrates advantageous features of the inlet air processing system according to an embodiment of the invention; and

FIG. 3 illustrates processes included in processing inlet air to the compressor portion of a turbomachine according to an embodiment of the invention.

The detailed description explains embodiments of the invention, together with advantages and features, by way of example with reference to the drawings.

### DETAILED DESCRIPTION OF THE INVENTION

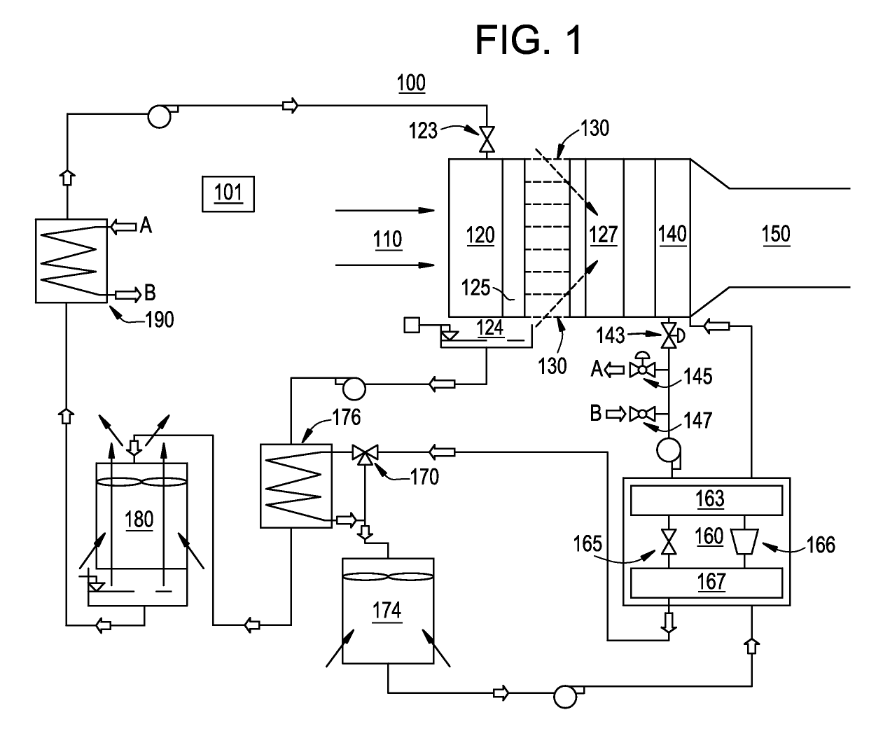

FIG. 1 is a block diagram of an inlet air processing system 100 according to an embodiment of the invention. The air processing system 100 ensures that cool dry air enters the compressor portion 150 of a turbomachine. As such, it can be thought to include a dehumidifying portion and a chilling portion. The condition of ambient inlet air 110 entering the air processing system 100 is considered in whether or not dehumidification is needed. Assuming that the ambient inlet air 110 needs to be dehumidified, the absorber valve 123 is opened to allow liquid desiccant (sorbent) to be sprayed as a cold and concentrated solution on top of the absorber 120. The liquid desiccant may be, for example, Lithium Chloride. The absorber 120 includes packing materials that allow the liquid desiccant to trickle down through the effect of gravity and allows incoming inlet air 110 to pass through. In an alternate embodiment, the filter module 127 includes a series of spray nozzles rather than the absorber 120 including packing material. The nozzles can be arranged such that atomized sorbent is sprayed across the incoming inlet air 110 to allow minimal carryover. In further embodiments, alternate spraying arrangements are also possible.

In the embodiment of the absorber with packing materials, the sorbent absorbs moisture from the incoming inlet air 110 as it trickles down the absorber 120, and the resulting warm and diluted solution is collected at the sump 124 at the bottom of the absorber 120. A drift eliminator 125 is downstream of the absorber 120 and prevents solution carryover into the compressor portion 150. The drift eliminator 125 may not be needed when the absorber 120 is used, because the absorber 120 removes moisture from the inlet air 110 entering the drift eliminator 125. However, when the absorber 120 is not used, the drift eliminator 125 may remove some moisture from the inlet air 110. The drift eliminator 125 is also helpful when the velocity of the inlet air 110 is high because the drift eliminator 125 acts as a baffle and introduces multiple directional changes to the air output from the absorber 120.

When the incoming ambient inlet air 110 does not require dehumidification, the absorber valve 123 is kept closed to prevent sorbent from entering the absorber 120 so that the dehumidifying process can be bypassed. Also, in this case, the bypass louvers 130 are opened. By opening the bypass louvers 130 when the absorber 120 is not being used to dehumidify, pressure drop of the inlet air 110 due to the absorber 120 does not increase. When dehumidification is performed, the bypass louvers 130 are kept closed. After passing through a filter module 127, the inlet air 110 (whether or not it was dehumidified by the absorber 120) passes through the inlet chilling coils 140 before being input to the compressor portion 150. The inlet chilling coils 140 are supplied with chilled water from the evaporator 163 to cool the inlet air 110 entering the compressor portion 150. Because the inlet air 110 coming into the inlet chilling coils 140 is dry, whether it was dehumidified or whether it was dry enough not to require dehumidification, the chilled water in the chilling coils 140 need only take away sensible heat from the inlet air 110. That is, there is almost no condensation and, thus, no related latent heat of condensation. As a result, the chilling coils 140 can be relatively smaller than those of prior systems. In an alternate embodiment, the inlet chilling coils 140 can be placed upstream of the inlet filters (between the bypass louvers 130 and filter module 127). In the alternate embodiment, the inlet air processing system 100 can be installed on existing turbo machinery.

The absorber 120 is part of one of the loops shown in FIG. 1 associated with the dehumidifying portion. The solution collected at the sump 124 below the absorber 120 following dehumidification is warm and diluted. This solution is forwarded by a forwarding pump to the pre-regenerator 176, where the solution is passed through a series of heat exchangers. By increasing the temperature of the brine solution, the pre-regenerator 176 increases the vapor pressure and facilitates easier removal of the absorbed moisture in the solution by the regenerator 180. The regenerator 180 may be an air-cooled heat exchanger, for example. The hot concentrated solution from the regenerator is cooled as it is routed through the cooler 190 and readied for entry into the absorber 120 based on the position of the absorber valve 123. In the discussion below, the interaction of this loop associated with the dehumidifying portion and a loop associated with the chilling portion are discussed, particularly with regard to the pre-regenerator 176 and cooler 190.

The chilling coils 140 are part of the other one of the loops shown in FIG. 1 associated with the chilling portion. The chilling coils 140 carry chilled water (circulated by a compressor) and, based on a controller (e.g., 101), the temperature control valve 143 is opened to let out water from the chilling coils 140. The controller 101 also controls valves 145 and 147 to send and receive water to/from the cooler 190 in the loop of the dehumidifying portion (indicated by “A” and “B” in FIG. 1), as needed. That is, valve 145 may be opened to divert water exiting the chilling coils 140 into the cooler 190 (A). This water entering the cooler 190 at A is not as cold as the water that enters the chilling coils 140 to cool the inlet air 110 but is relatively cooler than the warm desiccant coming from the regenerator 180 into the cooler 190 and, thus, is an effective coolant. Depending on the valve 143, 145, 147 positions, water from the cooler 190 (B) or from the chilling coils 140 enters the chiller module 160. The chiller module 160 includes an evaporator 163, condenser 167 and valves 165, 166 between the condenser 167 and the evaporator 163 that circulate refrigerant within the chiller module 160 and cool the evaporator 163 and heat the condenser 167. The water from the cooler 190 (B) or from the chilling coils 140 is cooled by the evaporator 163 and returns to the chilling coils 140. On the other side of the chiller module 160, the condenser 167 warms water that then passes to the three-way bypass valve 170. If the environmental conditions are such that dehumidification is needed and the absorber 120 is used (absorber valve 123 is open), then the warm water is first routed through a pre-regenerator 176, where it helps heat the sorbent from the sump 124 that resulted from dehumidification. On the other hand, if dehumidification is not needed (absorber valve 123 is closed), then the warm water from the chiller module 160 is routed directly to the cooling tower 174, where a fan drives air across the warm water to cool it. This cooled water is sent back through the condenser 167 of the chiller module 160 and is warmed.

The dehumidifying portion and chilling portion described above may be controlled by one or more controllers 101. For example, the controller 101 described above as controlling the temperature control valve 143 may be one of a plurality of separate controllers 101 that may communicate with each other or may be integrated to control the various operations of the inlet air processing system 100 (e.g., bypass louvers 130, valves 145, 147). The controller 101 may be housed within the inlet air processing system 100, as shown, or may be housed separately and in communication with the inlet air processing system 100. Further, controller(s) 101 may ultimately be integrated with one or more controllers of the turbomachine. Each controller 101 includes one or more processors and one or more memory devices. In addition, a user input may be available to additionally control or to override automated control of the inlet air processing system 100. For example, the inlet air processing system 100 may be controlled to always include the dehumidifying portion and close the bypass louvers 130 regardless of the ambient conditions.

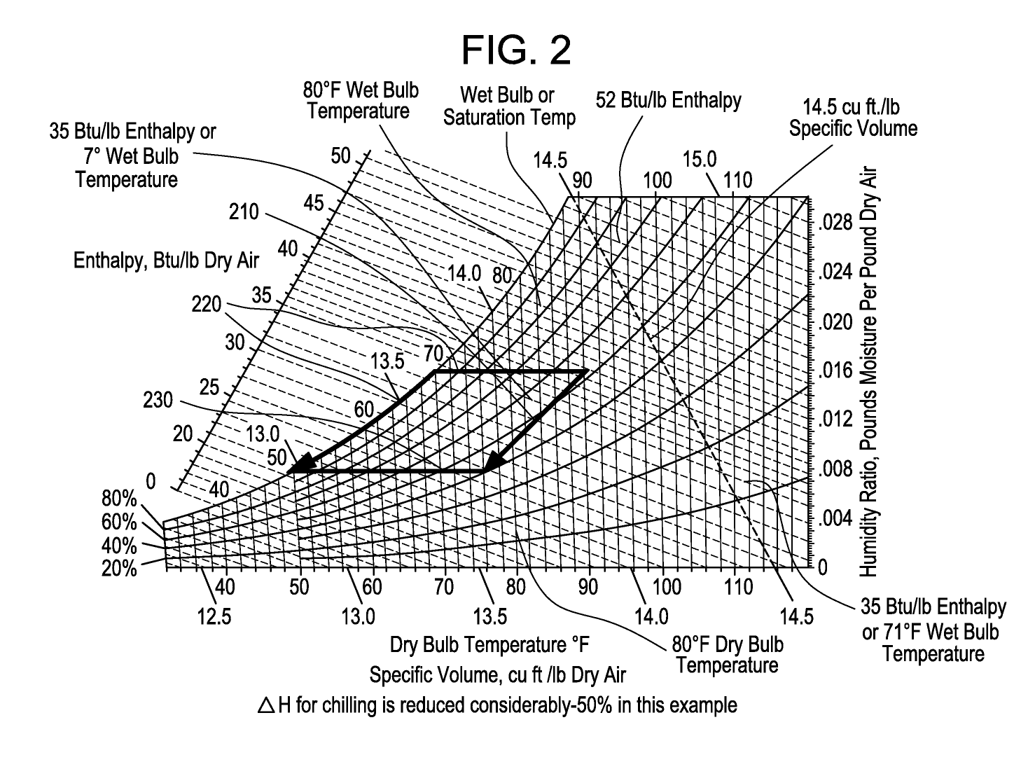

FIG. 2 illustrates advantageous features of the inlet air processing system 100 according to an embodiment of the invention. The line 210 pertains to the inlet air processing system 100 and illustrates that the combined dehumidification process and chilling process result in a steady and efficient decrease in both humidity and temperature of inlet air 110. The lines 220 pertain to a conventional chilling process in which both sensible and latent heat must be removed. This can result in the need for a larger chiller system. The line 230 pertains to a chilling system that removes sensible heat only. As the line 230 shows, humidity ratio remains unchanged for the inlet air 110 in this case. For a given system, the size of the inlet chiller is determined by the enthalpy difference (enthalpy is indicated in FIG. 2). The fact that the enthalpy difference is much lower for the line 230 than for the line 220 indicates that the line 230 (pertaining to a chilling system that removes sensible heat only) requires a smaller inlet chiller system than the line 220 (pertaining to a conventional chilling process in which both sensible and latent heat are removed). Because dehumidification and chilling are handled separately by the inlet air processing system 100, the inlet chiller with chilling coils 140 for the inlet air processing system 100 can be smaller (comparable to the size for line 230) than if dehumidification and cooling were both handled by the inlet chiller (as for line 220).

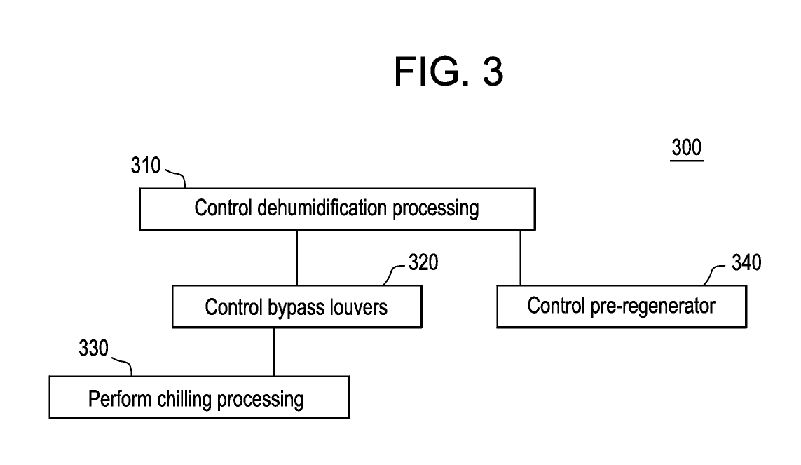

FIG. 3 illustrates processes 300 included in processing inlet air to the compressor portion 150 of a turbomachine according to an embodiment of the invention. The processes 300 have the technical effect of providing cool and dry inlet air to the compressor portion 150 of the turbomachine regardless of the ambient environment. At block 310, controlling the dehumidification processing includes opening the valve 123 or other flow control means to allow liquid desiccant into the absorber 120 if dehumidification of the inlet air 110 is to be performed and closing the valve 123 or otherwise inhibiting the flow of liquid desiccant if dehumidification of the inlet air 110 is not to be performed. At block 320, controlling the bypass louvers 130 includes opening the bypass louvers 130 when dehumidification of the inlet air 110 is not to be performed so as not to increase pressure drop of the inlet air 110 due to the absorber 120. At block 330, performing chilling processing on the inlet air 110 includes channeling the inlet air 110 from the bypass louvers 130 into the chilling coils 140 prior to the inlet air 110 entering the compression portion 150 of the turbomachine. At block 340, controlling the pre-regenerator 176 includes controlling the three-way bypass valve 170 such that warm water from the chiller module 160 is diverted through the pre-regenerator 176 only when the dehumidification processing was performed, resulting in sorbent entering the pre-regenerator 176 from the sump 124.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A system to process inlet air, the system comprising:
a dehumidifying portion configured to dehumidify the inlet air;
a chilling portion configured to cool the inlet air;
bypass louvers configured to open and close, the bypass louvers being open to channel the inlet air to the chilling portion when the dehumidifying portion is not operational; and
a control portion configured to operate the bypass louvers.

2. The system according to claim 1, wherein the control portion is configured to operate the bypass louvers based on a humidity of the inlet air.

3. The system according to claim 1, wherein the dehumidifying portion includes an absorber configured to channel a sorbent over the inlet air to output a solution.

4. The system according to claim 3, wherein when the dehumidifying portion is not operational, the control portion controls an absorber valve to prevent a supply of the sorbent into the absorber.

5. The system according to claim 3, wherein the sorbent is a liquid desiccant.

6. The system according to claim 3, wherein the chilling portion includes chilling coils supplied with chilled water from a chiller module and outputs warm water after cooling the inlet air.

7. The system according to claim 6, further comprising:
a pre-regenerator controlled to receive inputs of warm water output from a condenser to warm the solution resulting from dehumidification of the inlet air by the sorbent in the absorber.

8. The system according to claim 7, further comprising:
a cooler controlled to receive the warm water output from the chilling coils and cool the solution, output from the pre-regenerator and further heated by a regenerator.

9. A method of processing inlet air, the method comprising:
controlling dehumidification processing of the inlet air;
controlling bypass louvers based on the dehumidification processing, the bypass louvers being controlled to open when the inlet air does not undergo the dehumidification processing; and
performing chilling processing of the inlet air.

10. The method according to claim 9, wherein the controlling of the dehumidification processing of the inlet air is based on a humidity of the inlet air.

11. The method according to claim 9, wherein the dehumidification processing includes channeling a sorbent over the inlet air in an absorber and outputting a solution.

12. The method according to claim 11, wherein controlling the dehumidification processing includes preventing a supply of the sorbent into the absorber.

13. The method according to claim 11, wherein the performing the chilling processing includes channeling the inlet air across chilling coils supplied with chilled water from a chiller module and outputting warm water.

14. The method according to claim 13, further comprising:
controlling a flow, into a pre-regenerator, of warm water output from a condenser and the solution resulting from dehumidification of the inlet air by the sorbent in the absorber.

15. The method according to claim 14, further comprising:
controlling a flow of the warm water output from the chilling coils into a cooler configured to cool an output of the solution from the pre-regenerator after further heating in a regenerator.

16. A computer-readable medium storing instructions that, when processed by a processor, cause the processor to execute a method of processing inlet air, the method comprising:
controlling dehumidification processing of the inlet air;
controlling bypass louvers based on the dehumidification processing, the bypass louvers being controlled to open when the inlet air does not undergo the dehumidification processing; and
performing chilling processing of the inlet air.
